(19) United States
(12) Patent Application Publication
(10) Pub. No.: US 2003/0019642 A1
(43) Pub. Date: Jan. 30, 2003

(54) Hydraulic disc/harrow apparatus, system and method for using the same

(76) Inventor: John P. Moyna, Elkader, IA (US)

Correspondence Address: PATENTS+TMS, A Professional Corporation, 1914 North Milwaukee Avenue, Chicago, IL, 60647, US

(21) Appl. No.: 09/918,401

(22) Filed: Jul. 30, 2001

(51) Int. Cl. A01B 63/112

(52) U.S. Cl. 172/2; 172/315

(57) ABSTRACT

An apparatus has a frame with wheels and a plurality of discs, and a method for using the same is provided. More specifically, the apparatus has an assembly such that the bearings and tires may remain lubricated with minimal maintenance. The frame may have dual cylinders such that the frame may be adjusted during use. The cylinders may be adjusted by an individual by a remote controller such that a single operator may remotely control the elevation of the apparatus and/or the angle of the apparatus with the soil. Alternatively, one of the cylinders may automatically adjust to the terrain. Further, the apparatus has a rotatable connector such that the apparatus may be attached to a tractor by an individual.

### BACKGROUND OF THE INVENTION

The present invention generally relates to an apparatus having a frame with wheels and a plurality of discs attached to the frame and a method for using the same. More specifically, the present invention relates to an apparatus having dual hydraulic cylinders such that the frame may adjust during use of the apparatus. Moreover, the present invention provides an apparatus and a method that provides lubrication to bearings and/or tires of the apparatus. Further, the apparatus of the present invention may be attached to a tractor by a single individual.

It is, of course, generally known to provide a harrow or disc that is pulled behind, for example, a tractor. The harrow is generally used to lift and/or divide compacted soil or dirt or mud from the ground. Often, a harrow is used, for example, at a construction site or on a farm to raise or lift the soil to speed the drying of the soil in preparation for construction or for cultivation purposes, such as plants, for example, respectively.

Known harrows are generally pivotally secured to the tractor and have discs secured to a frame of the harrow. A bearing assembly is typically positioned between the frame to permit the discs to rotate at the same time that the discs penetrate the soil and turn over the soil. In operation, the discs penetrate the ground and turn over the soil to allow for aeration of top layers of the soil. Depending on the size of the disc, various depths of soil may be turned over. Depth of penetration of the discs into the soil is also variable based on angles and/or pressures of the discs as the discs are pulled over the soil.

To adjust the angles of the penetration of the discs into the soil, currently, an operator of the tractor, truck or the like that is pulling the harrow must stop the tractor and manually adjust the height and/or the angles at which the discs penetrate the soil. This typically is effected by manually adjusting a screw that shifts the frame on which the discs are rotatably mounted. This process to adjust the discs is both difficult and time-consuming.

Another problem associated with harrows includes requiring more than one person to physically attach the harrow to a tractor. Further, maintaining the bearings and/or tires in a clean and lubricated state is difficult with currently available harrows.

A need, therefore, exists for a method and an apparatus that adjusts to accommodate uneven terrain, connects to a tractor by a single individual and maintains the bearings and/or tires in a lubricated state.

### SUMMARY OF THE INVENTION

The present invention provides an apparatus having an assembly such that the bearings and tires may remain lubricated and the frame may adjust vertically during use thereof. Further, the apparatus of the present invention may be attached to a tractor by a single individual. Further, a method for using the apparatus of the present invention is provided.

To this end, in an embodiment of the present invention, an apparatus for separating soil is provided. The apparatus has a frame, a cylinder associated with the frame and a plurality of discs attached to the frame. The cylinder moves the frame. The apparatus has a controller associated with the cylinder. The controller is remote from the frame and controls movement of the frame.

In an embodiment, the apparatus has a front cylinder on the frame.

In an embodiment, the apparatus has a pillar associated with the frame and a column inside the pillar. The pillar may have a liner attached to an inside of the pillar of the frame. The pillar may have plates inside the pillar supporting the column.

In an embodiment, the apparatus has a hitch having a length defined between an end and a connector wherein the end of the hitch is attachable to the frame.

In an embodiment, the connector of the apparatus for separating soil rotates 360 degrees.

In an embodiment, the apparatus has tires supporting the frame. The tires have a plug in each of the tires of the frame.

In another embodiment of the present invention, a method for dividing soil is provided. The method is comprised of the steps of: providing a frame; providing a cylinder associated with the frame; connecting the frame to a tractor; moving the frame by remotely controlling movement of the cylinder; and pulling the frame over the soil.

In an embodiment, the method for separating soil further comprises of the step of providing a plurality of discs attached to the frame.

In an embodiment, the method for separating soil further comprises of the step of controlling elevation of the frame by adjusting the cylinder.

In an embodiment, the method for separating soil further comprises of the step of adjusting an angle of the frame with the soil by adjusting the cylinder.

In an embodiment, the method for separating soil further comprises of the step of self-adjusting the cylinder of the frame for controlling the angle of the frame with the soil.

In another embodiment of the present invention, an apparatus for separating soil is provided. The apparatus has a frame, a plurality of discs attached to the frame, a pillar associated with the frame and a column inside the pillar. The pillar has a liner attached to an inside of the pillar of the frame. The plates associated with the pillar support the column.

In an embodiment, the apparatus has a cylinder associated with the frame wherein the cylinder moves the pillar and the frame relative to the inside column.

In an embodiment, the apparatus has a front cylinder on the frame wherein the front cylinder moves to adjust the angle of the frame relative to the soil.

In an embodiment, the apparatus has a hitch having a length defined between an end and a connector wherein the end of the hitch is attachable to the frame.

In an embodiment, the connector of the apparatus for separating soil rotates 360 degrees.

In an embodiment, the apparatus for separating soil has tires supporting the frame.

It is, therefore, an advantage of the present invention to provide an apparatus and a method for attaching the apparatus to a tractor by a single individual.

Another advantage of the present invention is to provide an apparatus and a method for adjusting the apparatus for uneven terrain by a single operator.

Yet another advantage of the present invention is to provide an apparatus and a method for using the same wherein discs of the apparatus may be adjusted during use.

A still further advantage of the present invention is to provide an apparatus and a method that provides adjustment of the apparatus for uneven terrain by a remote controller.

Moreover, an advantage of the present invention is to provide an apparatus and a method for automatic adjustment of the apparatus for uneven terrain by a hydraulic cylinder.

Yet another advantage of the present invention is to provide an apparatus and a method for automatically and continuously lubricating bearings with little maintenance.

Another advantage of the present invention is to provide an apparatus and a method for automatically and continuously lubricating wheels with little maintenance.

Additional features and advantages of the present invention are described in, and will be apparent from, the detailed description of the presently preferred embodiments and from the drawings.

### BRIEF DESCRIPTION OF THE DRAWINGS

FIG. 1 illustrates a perspective view of a hydraulic disc/harrow apparatus in an embodiment of the present invention.

FIG. 2 illustrates a perspective view of an upper frame of the hydraulic disc/harrow apparatus in an embodiment of the present invention.

FIG. 2A illustrates a cross-sectional view taken generally along lines A-A of FIG. 2 of a pillar of the hydraulic disc/harrow apparatus in an embodiment of the present invention.

FIG. 2B illustrates a cross-sectional view taken along lines B-B of FIG. 2 of a pillar of the hydraulic disc/harrow apparatus in an embodiment of the present invention.

FIG. 3 illustrates a perspective view of a hydraulic piston of the hydraulic disc/harrow apparatus in an embodiment of the present invention.

FIG. 4 illustrates a perspective view of a connector in an embodiment of the present invention.

FIG. 5 illustrates a tire of the hydraulic disc/harrow apparatus in an embodiment of the present invention.

### DETAILED DESCRIPTION OF THE PRESENTLY PREFERRED EMBODIMENTS

The present invention generally provides an apparatus and a method having dual hydraulic cylinders that may allow a frame of the apparatus to be remotely adjusted during use. Further, the apparatus may have bearings and tires that may remain lubricated. Further, the present invention provides an apparatus and a method for attaching the apparatus to a tractor, for example, by an individual.

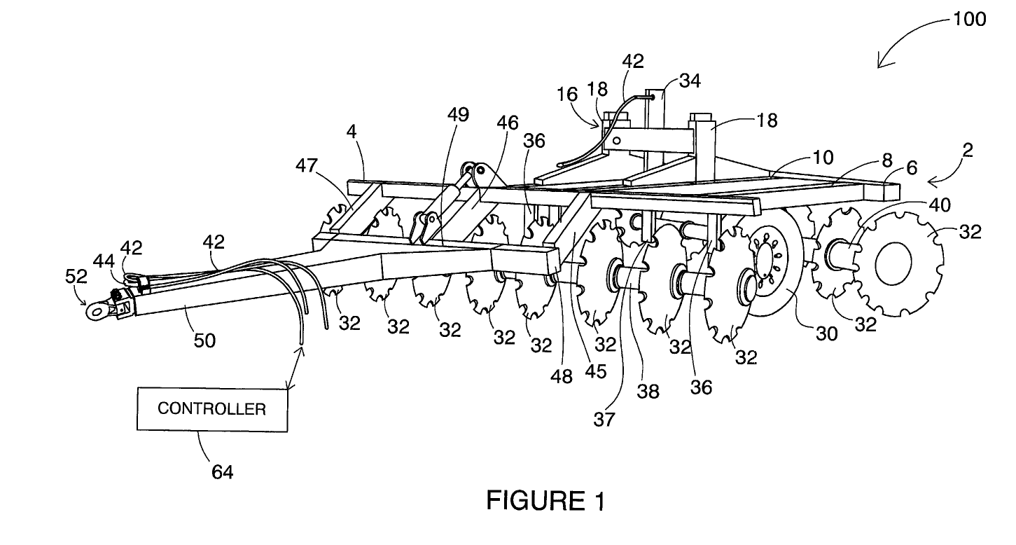

Referring now to the drawings wherein like numerals refer to like parts, FIG. 1 illustrates an apparatus 100 in an embodiment of the present invention. The apparatus 100 may have a frame 2 having a first bar 4 and a second bar 6. Arms 46 may extend outward and downward from the first bar 4 of the frame 2. The arms 46 may attach to a base bar 48 of a hitch 50. The hitch 50 may have a length defined by the base bar 48 and a connector 52.

The first bar 4 and the second bar 6 may be connected by a first cross member 8, a second cross member 10, a third cross member 12 and/or a fourth cross member 14. The first cross member 8, the second cross member 10, the third cross member 12 and the fourth cross member 14 may each define a length between the first bar 4 and the second bar 6. Preferably, the length of the fourth cross member 14 is greater than the length defined by the third cross member 12. Further, preferably, the length of the third cross member 12 is greater than the length defined by the second cross member 10. Further still, preferably, the second cross member 10 is greater than the length defined by the first cross member 8. The preferred configuration of the fourth cross member 14 having a length greater than the length of the third cross member 12, having a length greater than the second cross member 10, having a length greater than the first cross member 8 defines a frame 2 configured such that the first bar 4 and the second bar 6 are non-parallel.

The first bar 4 and the second bar 6 may have legs 36 depending from the first bar 4 and the second bar 6. The legs 36 depending from the first bar 4 support a first disc axis 38. The legs 36 depending from the second bar 6 support a second disc axis 40. The first disc axis 38 and the second disc axis 40 support a plurality of discs 32.

Accordingly, in a preferred embodiment, the legs 36 depending from the first bar 4 are not parallel to the legs 36 depending from the second bar 6. Therefore, the first disc axis 38 is not parallel to the second disc axis 40. Thus, the discs 32 attached to the first disc axis 38 are not parallel to the disc attached to the second disc axis 40. The discs 32 attached to the first disc axis 38 form an angle with the discs 32 attached to the second disc axis 40.

When the apparatus 100 is in use, the frame 2 is pulled forward and the discs 32 of the frame 2 act as a soil breaking means. As the frame 2 is pulled forward, the discs 32 penetrate the ground and turn over the soil allowing for aeration of the soil.

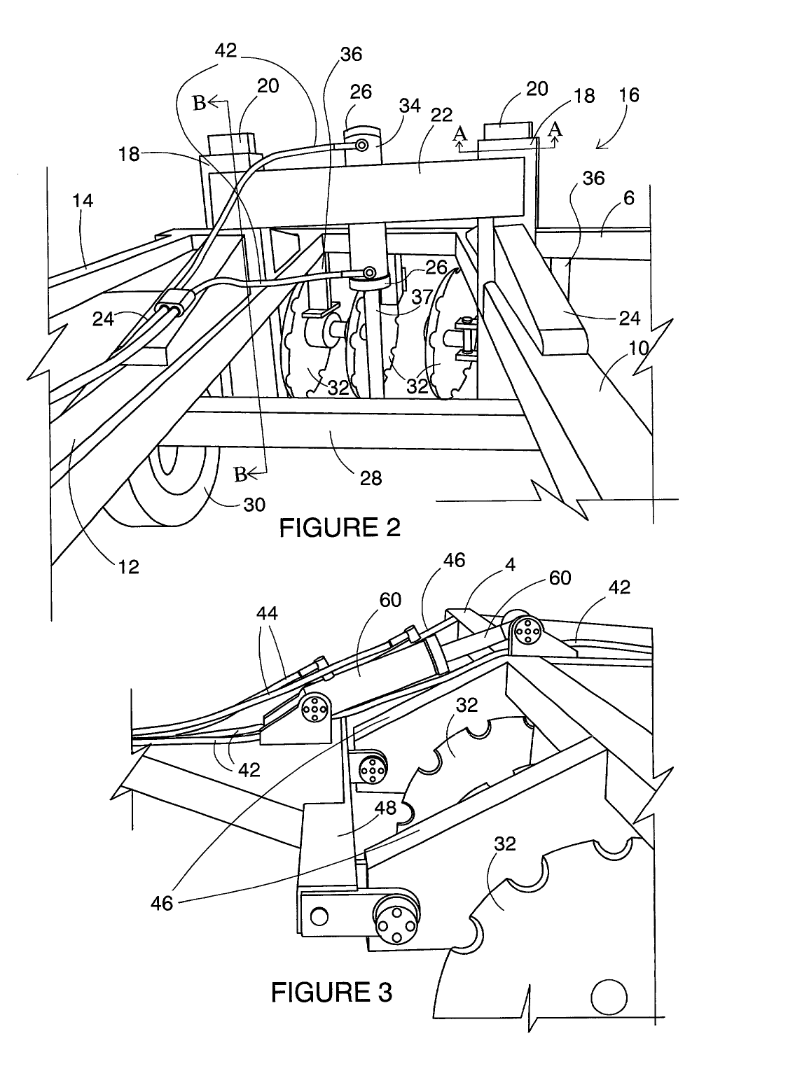

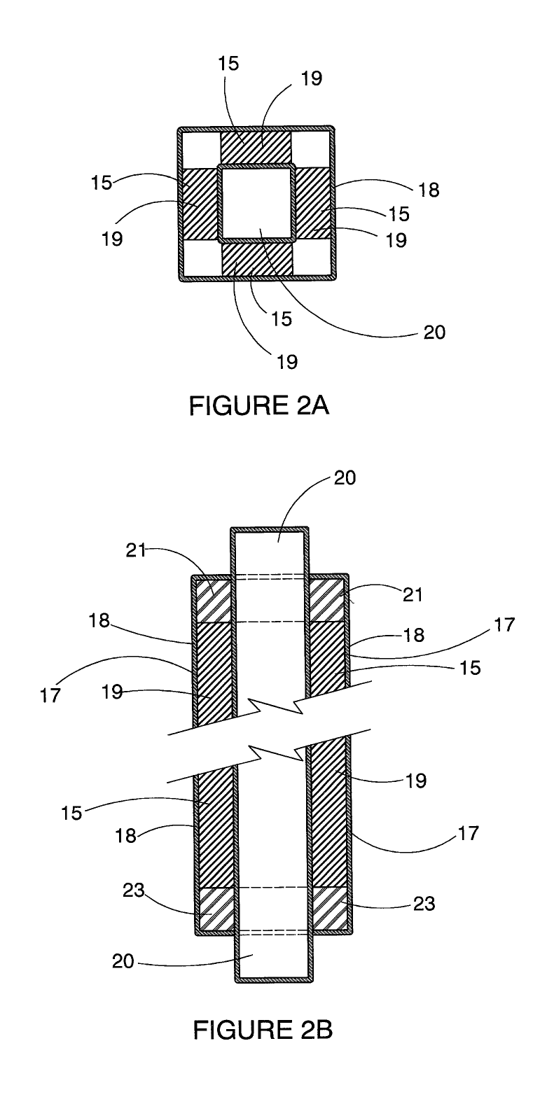

An upper frame 18 may be mounted on the second cross member 10 and the third cross member 12 such that the upper frame 18 may be substantially centered on the frame 2. Referring now to FIG. 2, the upper frame 16 may have pillars 18 attached by a bar 22. As illustrated, the pillars 18 have substantially square cross-sections, however, other shapes may be implemented, such as a rectangular cross-section, circular cross-section or an oval-shaped cross-section or the like. The pillars 18 may be secured substantially perpendicular to the second cross member 10 and the third cross member 12.

The pillars 18 may each have a base 24 attached to the upper frame 16. Further, the pillars 18 may each house an inner column 20. The inner column 20 may extend downward, through the upper frame 16 and the frame 2, to a wheel axis 28. A liner 19, preferably plastic, may cover a length of the inside of each of the pillars 18 (as shown in FIG. 2A). The liner 19 preferably has a one-half inch thickness. The liner 19 may be constructed from, for example, four plastic pieces 15 that substantially or at least partially cover each interior side 17 of the pillars 18. In the preferred embodiment, the plastic pieces 15 may be retained at the top and bottom of the pillars 18 by a top plate 21 and a bottom plate 23, respectively (as shown in FIG. 2B).

A cylinder 34 may be attached to the center of the bar 22 and to the wheel axis 28. Preferably, the cylinder 34 is mounted vertically with respect to the frame 2 and the wheel axis 28. A piston 37 may be attached by end plates 26 to the inside of the cylinder 34. The piston 37 may raise and/or lower the frame 2 as well as the upper frame 16 relative to the wheel axis 28. The pillars 18 of the upper frame 16 may move relative to the inner columns 20. The liner 19 inside the pillars 18 may provide a smoother surface and thus less friction for the inner columns 20 to move relative to the pillars 18 when the piston 37 raises and lowers the frame 2 as well as the upper frame 16.

The piston 37 may be actuated by a controller 64 as generally illustrated in FIG. 1. Preferably, the controller 64 is located inside a tractor, truck or other like vehicle having the ability to pull the apparatus 100 across the terrain. Accordingly, an operator of the tractor may vertically adjust the apparatus 100 using the controller 64 and its associated functions by moving the cylinder 34 without having to exit the tractor. Preferably, the cylinder 34 may raise or lower the frame 2 of the apparatus 100 by two feet. The piston 37 may be actuated by the controller 64 controlling fluids to and from the piston 37 via conduits 42.

Referring now to FIG. 3, a front cylinder 60 may be provided with a hydraulic piston 62 on one of the arms 46. The front cylinder 60 and the hydraulic piston 62 may be controlled remotely by the controller 64 (as generally shown and described with reference to FIG. 1), or alternatively, may be set to automatically adjust. Setting the hydraulic piston 62 to automatically adjust may allow the hydraulic piston 62 to “float” thereby acting much like a shock absorber and responding directly to the changes in terrain without control of the depth and/or angle of penetration of the discs 32 by an operator via the controller 64 of the apparatus 100.

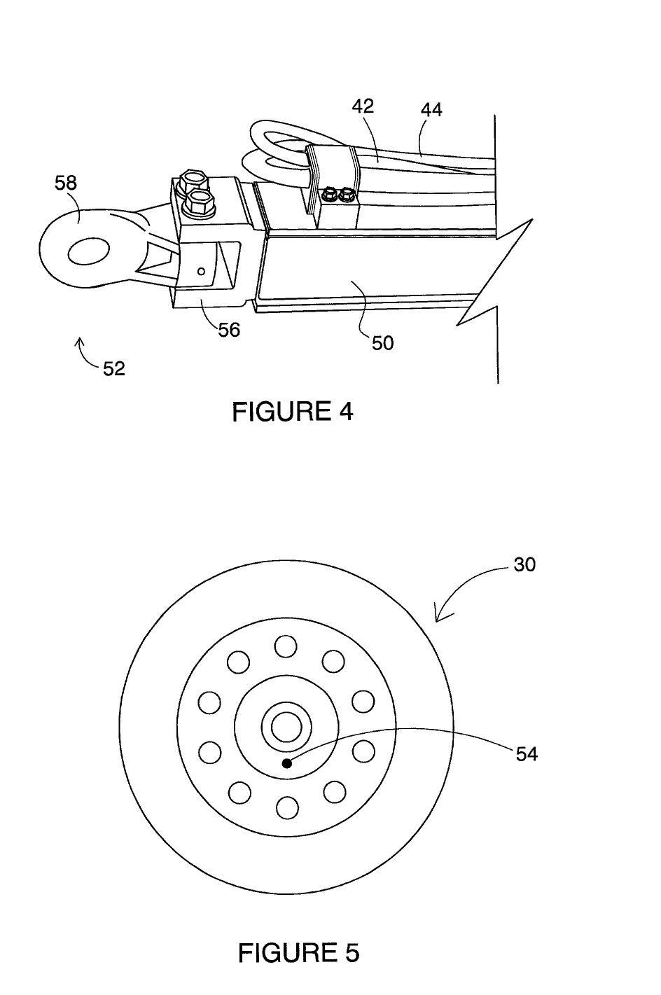

Referring now to FIG. 4, the connector 52 may have a base 56 and a ring 58. The ring 58 may be attached to a tractor (not shown) wherein the tractor may pull the apparatus over the terrain. The connector 52, having the base 56 and the ring 58, may spin in a clockwise or counter-clockwise direction. The spinning capability of the connector 52 may allow for the connector to be attached to a tractor by an individual without the assistance of another individual.

Referring again to FIGS. 1 and 2, tires 30 may be attached to the wheel axis 28 on either end of the wheel axis 28. The tires 30 may support the frame 2, the upper frame 16 and the discs 32. As shown in FIG. 5, the tires 30 may be maintained in an oil bath. The oil bath may provide constant lubrication. Lubrication of the tires 30 may be provided directly by removing a screw plug 54 (shown in the “six o'clock” position in FIG. 5) on each of the tires 30 and filling a receptacle with oil until, preferably, the receptacle is half full. To this end, the tire 30 should be rotated such that the screw plug 54 is in the “nine o'clock” position or the “three o'clock” position. The oil may be added by removing the screw plug 54 and adding oil through the opening provided by removal of the screw plug 54. The opening provided access to a receptacle within the tire 30 providing an oil bath, i.e. constant, maintenance free lubrication for each of the tires 30. Accordingly, the oil bath provides for low maintenance lubrication of the tires 30 as the tires may remain constantly lubricated or lubricated at least for longer periods of time. Such lubrication saves time, as an operator may stop less frequently to adjust and/or maintain the apparatus 100.

Similar to the tires 30, a bearing assembly may provide bearings (not shown) with an oil bath (not shown) which may provide constant lubrication to the bearings. The bearing assembly (not shown) may be positioned between the frame 2 and the discs 32 to permit the discs 32 to rotate at the same time they penetrate soil and turn over the soil.

It should be understood that various changes and modifications to the presently preferred embodiments described herein will be apparent to those skilled in the art. Such changes and modifications may be made without departing from the spirit and scope of the present invention and without diminishing its attendant advantages.

I claim:

1. An apparatus for separating soil, the apparatus comprising:
a frame;
a cylinder associated with the frame;
a plurality of discs attached to the frame wherein the cylinder moves the frame; and
a controller associated with the cylinder wherein the controller is remote from the frame and controls movement of the frame.

2. The apparatus of claim 1 further comprising:
a front cylinder on the frame.

3. The apparatus of claim 1 further comprising:
a pillar associated with the frame; and
a column inside the pillar.

4. The apparatus of claim 3 further comprising:
a liner attached to an inside of the pillar of the frame.

5. The apparatus of claim 3 further comprising:
plates inside the pillar supporting the column.

6. The apparatus of claim 1 further comprising:
a hitch having a length defined between an end and a connector wherein the end of the hitch is attachable to the frame.

7. The connector of claim 6 wherein the connector rotates 360 degrees.

8. The apparatus of claim 1 further comprising:
tires supporting the frame.

9. The apparatus of claim 8 further comprising:
a plug in each of the tires of the frame.

10. A method for dividing soil, the method comprising the steps of:
providing a frame;
providing a cylinder associated with the frame;
connecting the frame to a tractor;
moving the frame by remotely controlling movement of the cylinder; and
pulling the frame over the soil.

11. The method of claim 10 further comprising the step of:
providing a plurality of discs attached to the frame.

12. The method of claim 10 further comprising the step of:
controlling elevation of the frame by adjusting the cylinder.

13. The method of claim 10 further comprising the step of:
adjusting an angle of the frame with the soil by adjusting the cylinder.

14. The method of claim 10 further comprising the step of:
self-adjusting the cylinder of the frame for controlling the angle of the frame with the soil.

15. An apparatus for separating soil, the apparatus comprising:
a frame;
a plurality of discs attached to the frame;
a pillar associated with the frame wherein the pillar has a liner attached to an inside of the pillar of the frame; and
a column inside the pillar wherein plates associated with the pillar support the column.

16. The apparatus of claim 15 further comprising:
a cylinder associated with the frame wherein the cylinder moves the pillar and the frame relative to the inside column.

17. The apparatus of claim 15 further comprising:
a front cylinder on the frame wherein the front cylinder moves to adjust the angle of the frame relative to the soil.

18. The apparatus of claim 15 further comprising:
a hitch having a length defined between an end and a connector wherein the end of the hitch is attachable to the frame.

19. The connector of claim 18 wherein the connector rotates 360 degrees.

20. The apparatus of claim 15 further comprising:
tires supporting the frame.
